(19) United States
(12) Patent Application Publication
(10) Pub. No.: US 2024/0183049 A1
(43) Pub. Date: Jun. 6, 2024

(54) Artificial Intelligence Pressure Control Multiple Track Injection Liquid-to-gas Conversion Method

(71) Applicants: Charles H Ng, Palo Alto, CA (US); Hokchung Ng, Toronto (CA)

(72) Inventors: Charles H Ng, Palo Alto, CA (US); Hokchung Ng, Toronto (CA)

(21) Appl. No.: 18/233,123

(22) Filed: Aug. 11, 2023

Related U.S. Application Data
(60) Provisional application No. 63/429,919, filed on Dec. 2, 2022.

(51) Int. Cl. C25B 15/027; C25B 1/04; C25B 15/029; C25B 15/08; G06F 17/18

(52) U.S. Cl. CPC C25B 15/027; C25B 1/04; C25B 15/029; C25B 15/08; G06F 17/18

(57) ABSTRACT

Electron exchangers are placed in the conversion cell and divide it into cathode gas chamber, liquid conversion solution chamber filled with a multiple track injection liquid controller, and anode gas chamber. Voltage is applied to the electron exchangers to convert the liquid conversion solution to gases, and gases are released directly to the gas chambers. On the surfaces of the single sheets of the multiple track injection liquid controller, there are many tracks and puncture channels that are designed by critical surface calculations, and manufactured with a precision technology. A computing engine connected to the cloud is responsible for artificial intelligence calculations, and it controls valves, sensors, servo motors, and enhance gas flow devices. In producing the same amount of final gases, our method is energy efficient.

### CROSS-REFERENCE TO RELATED APPLICATIONS

This application claims the benefit of Provisional patent application Ser. #U.S. 63/429,919 filed Dec. 2, 2022 by the present inventors, which is incorporated by reference in its entirety.

### TECHNICAL FIELD

The present invention relates to liquid to gas conversion method with an electrical voltage, specifically to such a method which is energy efficient.

### BACKGROUND ART

It is known in the prior art that liquid-to-gas conversion is commonly achieved by the application of a voltage to a liquid conversion solution through two pieces of conductive materials to produce final gases. With two pieces of conductive materials immersed in the liquid conversion solution, as anode and cathode, the conductive materials are under direct contact with the liquid conversion solution. Electrons are exchanged between these conductive materials and the liquid conversion solution, and final gases are released as bubbles from the immersed conductive materials. The gases float upward from the liquid conversion solution to the gas chambers above. This prior process is generally not energy efficient.

### SUMMARY

Our method provides an energy efficient liquid-to-gas conversion using artificial intelligence pressure control multiple track injection conversion cell.

### DRAWINGS—FIGURES

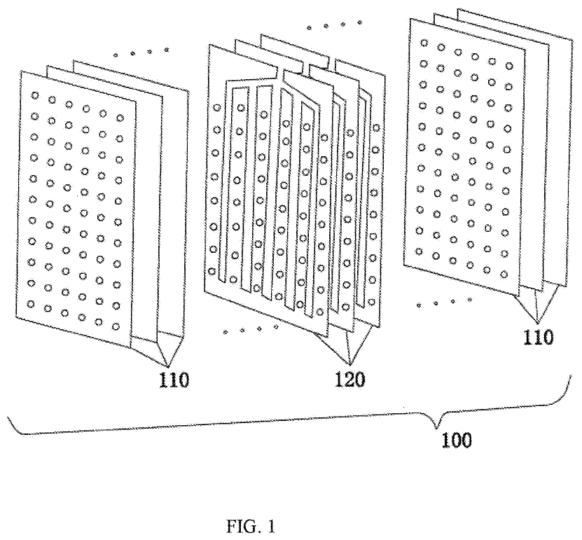

1) FIG. 1: Multiple track injection liquid controller, composed of three types of single sheets stacked together

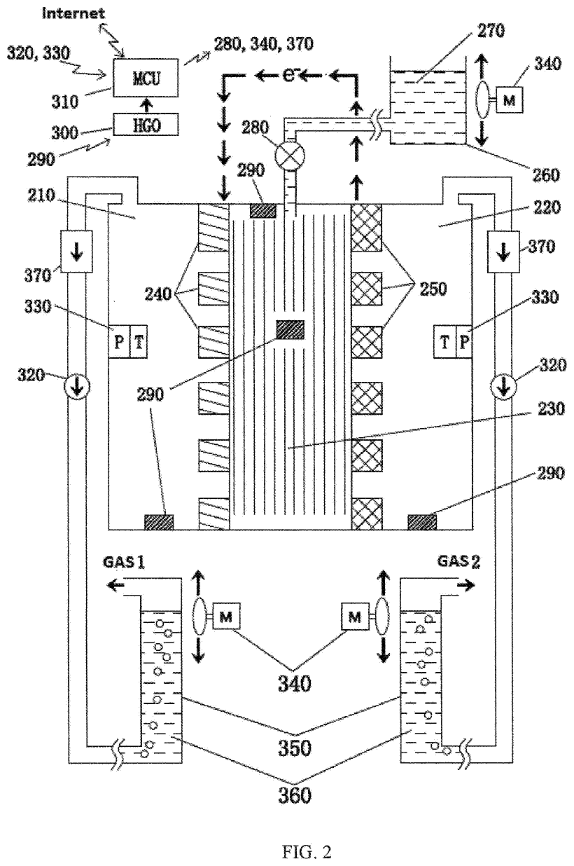

2) FIG. 2: Liquid-to-gas conversion cell

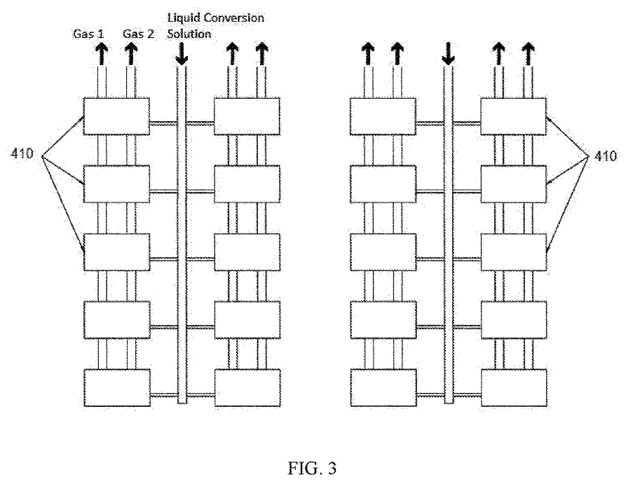

3) FIG. 3: Stacking of conversion cells

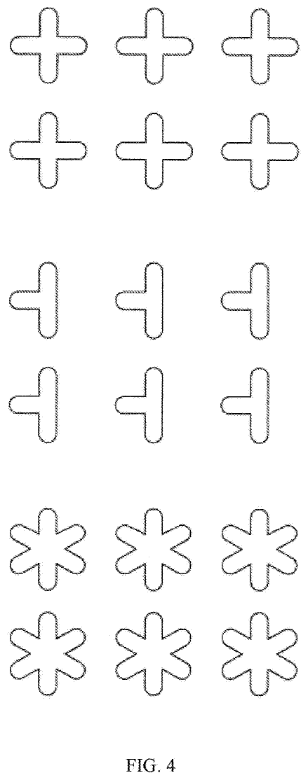

4) FIG. 4: Design patterns for puncture channels

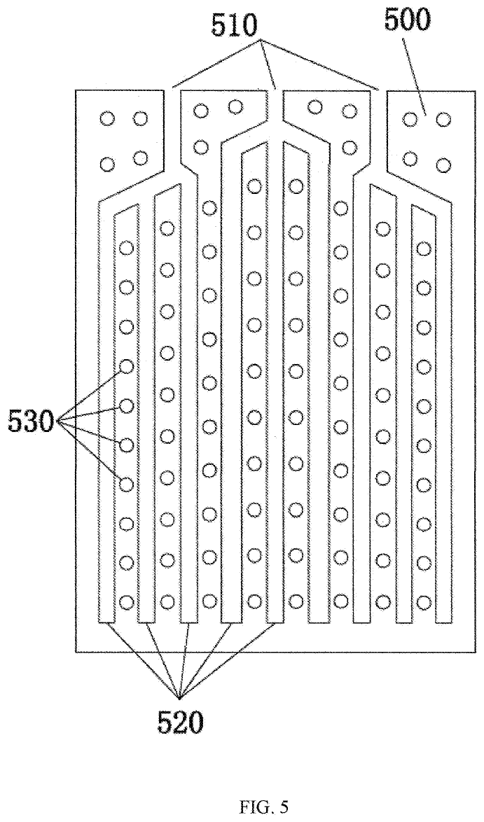

5) FIG. 5: Multiple track injection liquid control single sheet

### DRAWINGS—REFERENCE NUMERALS

100: Multiple track injection liquid controller
110: Combination of liquid control single sheets and liquid retention mesh material single sheets
120: Multiple track injection single sheets
210: Cathode gas chamber
220: Anode gas chamber
230: Liquid conversion solution chamber filled with the multiple track injection liquid controller
240: Cathode electron exchanger
250: Anode electron exchanger
260: Liquid reservoir
270: Liquid conversion solution
280: Liquid flow valve
290: Liquid content sensor
300: Hygrometer
310: Microprocessor (MCU)
320: Gas flow sensor
330: Temperature sensor and gas pressure sensor
340: Servo motor
350: Gas cleaning cell
360: Gas cleaning liquid
370: Enhance gas flow device
410: Liquid-to-gas conversion cell
500: Multiple track injection single sheet
510: Liquid inlets at the multiple track injection single sheet
520: Tracks of the multiple track injection single sheet
530: Puncture channels of the multiple track injection single sheet

### DESCRIPTION

Our method discloses an artificial intelligence pressure control multiple track injection liquid-to-gas conversion method.

The anode and the cathode electron exchangers are placed in the liquid-to-gas conversion cell, and the conversion cell is divided into, from one side to the other side, the cathode gas chamber, the liquid conversion solution chamber filled with the multiple track injection liquid controller, and the anode gas chamber. One side of the electron exchangers faces the liquid conversion solution chamber and in direct contact with the multiple track injection liquid controller, and this side is coated with non-conductive polymer material. The other side of the electron exchangers faces the gas chambers, and this side is conductive. The surfaces of the electron exchangers are covered with a number of puncture channels. Voltage is applied to the anode electron exchanger and the cathode electron exchanger, electrons are exchanged on the side that is facing the gas chambers, and the liquid conversion solution is converted into final gases, which are released separately into the cathode gas chamber and the anode gas chamber. Gases pass through the two gas chambers outlets to the cathode and anode gas cleaning cells gas inlets. Gas cleaning cells are filled with gas cleaning liquid. Gas bubbles rise from the gas inlets of the gas cleaning cells to the gas outlets at the top of the gas cleaning cells.

Solvent is added to the liquid conversion solution to ionize the molecules of the liquid conversion solution. The temperature and gas pressure of the conversion cell can be adjusted according to the gas production level, and the conversion rate of the conversion cell is increased accordingly.

The multiple track injection liquid controller is placed in the liquid conversion solution chamber, and the multiple track injection liquid controller is built with three types of nonconductive single sheets stacked together, comprising: multiple track injection single sheet, liquid control single sheet, and liquid retention mesh material single sheet. See FIG. 1. The number of single sheets ranges from 3 to 10,000 sheets or more.

The first type of single sheet is a multiple track injection single sheet that has a number of tracks and puncture channels on the surface, see FIG. 5. The tracks form a network of distribution channels from the multiple liquid inlets to the different locations across the multiple track injection single sheet. The multiple track distribution network helps the liquid to be injected evenly and quickly. In addition to the tracks, the sheet surface is also covered with many puncture channels with design patterns, see FIG. 4. The patterns enhance the ability of liquid conversion solution to adhere to the surfaces of the multiple track injection single sheets. A number of the multiple track injection single sheets are placed at the center of the multiple track injection liquid controller, and they are sandwiched from the left and from the right by a mixture of the second type of liquid control single sheets and the third type of liquid retention mesh material single sheets. The liquid control single sheets and the liquid retention mesh material single sheets protect against any gas bubbles getting through the multiple track injection single sheets in the middle.

The material for the first type and the second type of single sheet can be stainless steel, copper, or aluminum, and the sheet coated with nonconductive polymer material, such as titanium carbide TIC, or other materials with similar effects.

The second type of single sheet is a liquid control single sheet, and it has many puncture channels on the surface. The puncture channels have a specially designed pattern, see FIG. 4.

The third type of single sheet is liquid retention mesh material single sheet built with polymer or nylon meshed materials with a lot of pores. The mesh structure enhances the ability of liquid conversion solution molecules to adhere to the surface the liquid retention mesh material single sheet.

When the first type and the second type single sheets are stacked together, the puncture channels on adjacent single sheets are kept out of alignment with each other. In other words, the puncture channels from adjacent single sheets are located at different positions from each other, and they are separated to form a pattern of interlocking channels. These interlocks enhance the ability of liquid conversion solution molecules to adhere to the multiple track injection liquid controller.

The first type multiple track injection single sheets and the second type liquid control single sheets are manufactured by a precision technology, comprising: chemical etching, plasma etching, laser drilling or electroforming process. The manufacturing of the single sheets can begin with conductive or nonconductive materials. The first option is chemical etching, which is a relatively low-cost process to make the desired single sheets. This chemical etching process can be applied to a piece of conductive material of the desired specification, and chemicals etch away specific spots of the material to form the tracks or puncture channels. For the second option, it is also possible to plasma etching on a nonconductive polymer material, and plasma etches away specific spots of the nonconductive polymer material to form the tracks or puncture channels. The third option is laser drilling, in which a piece of conductive or non-conductive material that meets the requirements is repeatedly applied with pulsing focused laser energy to cut through the material to form the tracks or puncture channels. A fourth option is electroforming, where nanometer scale or micrometer scale metal devices are fabricated by electrodepositing on a pattern called a mandrel. The desired conductive material is electrodeposited on the mandrel to form the single sheets, the tracks, and the puncture channels. If the making of the single sheets starts from a conductive material, after the puncture channels are made by one of the above processes, the surface of the conductive material is coated with a nonconductive polymer material, such as Titanium Carbide, to make the single sheets nonconductive.

The third type liquid retention mesh materials single sheet is nonconductive and is manufactured by precision material woven technology.

The combination of various physical parameters, the design of the three types of single sheets, the stacking of the single sheets, the design of the multiple tracks, and the design of the puncture channels is the key to control the ability of the liquid conversion solution to adhere to the multiple track injection liquid controller, and to make the liquid conversion solution forming thin films on the single sheet critical surface. The thickness of the single sheet, the spacing between adjacent single sheets, the size of the multiple tracks, the size of the puncture channels, and the distance separating the channels should not be too large or too small, in the range of nanometers to micrometers, and should be calculated by the following method.

The liquid conversion solution stays on the critical surfaces of the single sheets as droplets. It will diffuse until a partial wetting equilibrium contact radius is reached. For a simple estimation calculation, the droplet radius r can be expressed as:

$$\\ r = \sqrt{\frac{V}{π h}} , where h = \sqrt{\frac{2 σ ( 1 - cos θ )}{ρ g}}$$

σ is the surface tension
g is the gravitational acceleration constant
θ is the contact angle between the liquid and the surface
h is the height of the droplet
V is the time function of the volume of the droplet

Using a more detailed model and calculations, the change in droplet radius r(t) over time can be expressed as:

$$\\ r ( t ) = {{r}_{e} [ 1 - exp ( - ( \frac{2 {γ}_{LG}}{{r}_{e}^{{}_{} 12}} + \frac{ρ g}{9 {r}_{e}^{{}_{} 10}} ) \frac{24 λ {V}^{{}_{} 4} ( t + {t}_{0} )}{{π}^{{}_{} 2} η} ) ]}^{\frac{1}{6}}$$

It is also possible to assume perfect spreading of the liquid conversion molecules and radius can be expressed as:

$$\\ r ( t ) = {[ {( {γ}_{LG} \frac{96 λ {V}^{{}_{} 4}}{{π}^{{}_{} 2} η} ( t + {t}_{0} ) )}^{\frac{1}{2}} + {( \frac{λ ( t + {t}_{0} )}{η} )}^{\frac{2}{3}} \frac{24 ρ {gV}^{\frac{3}{8}}}{7 \cdot {96}^{\frac{1}{3}} {π}^{\frac{4}{3}} {γ}_{LG}^{{}_{} \frac{1}{3}}} ]}^{\frac{1}{6}}$$

γLG is the surface tension of the liquid
V is the droplet volume
η is the viscosity of the liquid
ρ is the density of the liquid
g is the gravitational acceleration constant
λ is the shape factor, 37.1 m−1
t0 is the experimental delay time
re is the radius of the droplet at equilibrium

Assuming that the delay time is 0.1 to 2 seconds to calculate the droplet radius r,

The width of each track on the first type multiple track injection single sheet should be larger than r, this width should be set as 500% to 5,000% of r.

For the first type and the second type single sheet, the spacing between adjacent puncture channels should be set as 100% to 200% of the droplet radius.

For the first and second type single sheet, the radius of the puncture channel should be set as no larger than r.

The radius of the pores in the third type of liquid retention mesh material single sheet should be set as no larger than r.

In common liquid conversion solution materials, the width of the track can be from 500 micrometer to 5,000 micrometer, and the diameter of the pores and puncture channel can be from 100 nanometers to 100 micrometers. The size of the pores, the width of the multiple tracks, and size of the puncture channels can be adjusted based on the operating temperature, air pressure, as well as the desired gas production level.

On the same single sheet, the width of the track and the size of the puncture channel can be different. The size can be smaller or larger depending on whether their locations are closer to or farther away from the source of the liquid conversion solution.

For the three types of single sheet, the thickness and the distance between adjacent sheets can be calculated in the following:

The height h of a liquid column is given as

$$\\ h = \frac{2 γ cos θ}{ρ g r}$$

γ is the liquid-air surface tension coefficient (force/unit length),
Θ is the contact angle,
ρ is the density of liquid,
g is the gravitational acceleration constant, and
r is the radius of liquid column.

For the three types of single sheet, the thickness of the single sheets should be as no thicker than h. The thickness of the sheets is approximately equal to 100 nanometers to 100 microns in common liquid conversion solution materials. The thickness can be adjusted according to the operating temperature, air pressure, as well as the desired gas production level.

The multiple track injection liquid controller is formed by stacking a number of the three types of single sheet, and the spacing between adjacent single sheets should not be greater than 50% to 100% of h. In common liquid conversion solution materials, the spacing between individual sheets is approximately between 50 nanometers and 100 microns. The spacing can be adjusted according to the operating temperature, air pressure, as well as the desired gas production level.

The liquid conversion cell is equipped with an intelligent microprocessor (MCU) to carry out artificial intelligence machine learning calculation, and data is also transmitted to the local computing engine or to the cloud computing engine via the Internet for calculation. Microprocessor controls the liquid flow valves, enhance gas flow device, and the height servo motors, in order to adjust the liquid pressure, gas pressure, and temperature at the cathode gas chamber, the liquid conversion solution chamber, and the anode gas chamber, and affect the efficiency of the liquid conversion cell.

A liquid flow valve is placed at liquid inlet of the multiple track injection liquid controller and it feeds liquid conversion solution directly from the liquid reservoir to a number of the liquid inlets of the multiple track injection single sheets at the multiple track injection liquid controller. The microprocessor controls the flow valve and decides whether to increase or decrease the flow of the liquid conversion solution to the liquid inlets of the multiple track injection liquid single sheets.

Microprocessor is connected to a servo motor to control the height distance from the top of liquid in the liquid reservoir to the multiple track injection liquid controller, and the height distance directly controls the liquid pressure that is applied to the multiple track injection liquid controller.

Microprocessor is connected to another two servo motors to control the height distance from the top of the liquid inside the gas cleaning cells to the gas inlets inside the gas cleaning cells. This liquid height distance inside the gas cleaning cell controls the outlet gas pressure at the gas chambers inside the liquid conversion cell.

Microprocessor connects to two enhance gas flow devices, such as electric gas flow fans, at the outlets from the two gas chambers, and controls the gas flow in order to increase or decrease the gas pressure coming from the gas chambers.

The microprocessor fast response speed is around one to two seconds and can control these devices and various parameters in real time.

The microprocessor is also connected to four liquid content sensors, temperature sensors, pressure sensors, height distance sensors, gas flow sensors, voltage sensor, and current sensor. More sensors can be placed at selected locations within the conversion cell, liquid reservoir, and gas cleaning cells, if necessary. Each liquid content sensor has a pair of resistance probes to sense the liquid content of the liquid conversion solution at different locations in the conversion cell. The probes are made of anti-corrosion and anti-oxidation conductive materials, or they can be coated with highly conductive anti-corrosion and anti-oxidation materials to prevent the probe from oxidation over time.

The first liquid content sensor is placed at the liquid inlet side of the multiple track injection liquid controller, and the second liquid content sensor is placed near the middle of the multiple track injection liquid controller in order to detect the liquid content of the liquid conversion solution in those locations. The microprocessor senses that the liquid content at these locations, it will increase the flow valve when there is too little liquid, or decrease the flow valve when there is too much liquid, and control the liquid conversion solution flow from the liquid reservoir to the multiple track injection liquid controller.

The third and fourth liquid content sensors are placed at the bottom of the cathode gas chamber, and the bottom of the anode gas chamber. If the microprocessor senses that there is a certain amount of liquid conversion solution at these locations, it means there is too much liquid conversion solution entering the multiple track injection liquid controller, and the electron exchangers cannot keep up with the liquid-to-gas conversion. The microprocessor will decrease the liquid flow valve to slow the liquid conversion solution flow to the multiple track injection liquid controller.

The microprocessor is connected to multiple temperature sensors and the pressure sensors that are placed inside or around the cathode gas chamber, the liquid conversion solution chamber, and the anode gas chamber. The microprocessor is connected to two gas output flow sensors that are each placed at the gas outlet from the cathode and anode gas chambers. The microprocessor is connected to the voltage and current sensors to measure the electrical voltage and current applied to the cathode and anode electron exchangers. The microprocessor is connected to multiple position sensors to measure the height distance from the top of the liquid reservoir to the multiple track injection liquid controller, and to measure the height distance from the top of the liquid inside the gas cleaning cell to the gas inlet inside the gas cleaning cell.

More sensors in the conversion cell can be handled using a similar approach as described above.

Based on the amount of liquid in the multiple track injection liquid controller, temperature, gas pressure, liquid pressure, height distance, voltage and current, gas output flow rate, and required gas production output rate, the microprocessor can adjust the working pressure and temperature of the cathode gas chamber, the liquid conversion chamber, and the anode gas chamber. Due to the intelligent microprocessor control, the conversion and power consumption efficiency of the liquid conversion cell increases accordingly.

The microprocessor sends the sensor data to the local wired or wireless network, and transmits the data to the cloud computing engine through the Internet to perform the artificial intelligence calculation and store the data in the cloud storage. Due to security concerns, these data can also be transmitted to the local computing engine through wired or wireless network, and the artificial intelligence calculations can be completed in the local computing engine.

The artificial intelligence computing engine calculates the control instructions from the analysis results, and transmits the control instructions to the microprocessor of the conversion cell. At the same time, operators in various locations can read the data and the artificial intelligence calculation results from the cloud server through mobile phones and computer tablets.

Machine learning is specifically a predictive modeling technique, and the main objective is to minimize the error of the model, and to make the most accurate prediction possible. Machine learning algorithms are described as learning target predictive model that can be used to predict output data based on future input data. Through the training of a large amount of previous data, the machine learning model continues to learn and improve its accuracy in predicting the function output from future new input data.

Machine learning algorithm is described as learning an objective prediction function (F) that best maps series of input data (X) to an function output (Y), in other words, predicts an output (Y) based on an input (X).

Y=F(X)

The algorithm applied, regression analysis, is one of the branches of artificial intelligence machine learning. We use an combination regression analysis with algorithms, comprising: 1) single variable regression, 2) multi variable regression, 3) linear regression, and 4) nonlinear regression. In general, we can express the predictive function F(X) for the combination regression analysis as:

Y=F(X1,X2, . . . ,Xn),
series of function output=Y,
series of input data from Sensor 1=X1,
series of input data from Sensor 2=X2, . . . ,
series of input data from Sensor N or required gases output level=Xn.

Sensors 1 . . . N can be the liquid content sensors, temperature sensors, liquid pressure sensors, gas pressure sensors, gas flow sensors, height distance sensors, voltage sensor, or current sensor. X1 to Xn are the series of input data from the sensors or required gases output level.

In processing liquid content, temperature, pressure, gas flow, height distance, voltage, or current, if the data are within an accepted range, then Xn is set to 1, otherwise it is set to 0.

When training the model, series of input data X1, X2, . . . Xn and the “commonly well accepted” series of function outputs Y are collected as training data and fed into the model.

In our combination regression analysis, we first analyze the series of input data X1, X2, . . . Xn, divide each predictive function for one or more segments of input data ranges, and form sub predictive functions to obtain series of function outputs Y1, Y2, . . . Yk for each input data range. Over the whole input data range, predictive function F(X) is a combined result of all the sub predictive functions covering each of the input data range.

First, each series of input data of X1 to Xn is sorted into an ascending order. Express the first data point of series of input data X1 as X1.1, and the mth data point of series of input data X1 as X1.m. The increment in each input data Xn is compared to the increment in series of function output Y.

Express the increment from the 1^{st} X1 data point to the 2^{nd} X1 data point as

dX1.2=X1.2−X1.1,

dX1.3=X1.3−X1.2,

dX1.m=X1.m−X1.m−1

Express the increment in series of function output Y, as X1 data point moves from X1.1 to X1.m, and series of function output moves from Y1.1 to Y1.m, as

dY1.2=Y1.2−Y1.1,

dY1.3=Y1.3−Y1.2,

dY1.m=Y1.m−Y1.m−1

Express the increment in the Slope as X1 data point moves from X1.1 to X1.m as

Slope1.2=dY1.2/dX1.2,

Slope1.3=dY1.3/dX1.3,

Slope1.m=dY1.m/dX1.m

Repeat these steps for all series of input data from X1 to Xn, whenever detect an significant change in the Slope value, form a new set of input data for this segment of data input range, and group each set of input data for each segment of input data range to form a separate sub predictive function. Submit each set of input data for each sub predictive function for training and for predicting future series of function outputs to multiple regression algorithms, comprising: least-square linear regression algorithm, least-square non-linear regression algorithm, regression neural network algorithm, and other equivalent regression algorithm.

First submit series of input data to the least-square linear regression algorithm, as an example, in the case of single variable, the series of function output y can be expressed as:

$$\\ {y}_{i} = α + β {x}_{i} + {ε}_{i} ; \hat{β} = \frac{{\sum }_{i = 1}^{n} ( {x}_{i} - \overline{x} ) ( {y}_{i} - \overline{y} )}{{\sum }_{i = 1}^{n} {( {x}_{i} - \overline{x} )}^{2}}$$

$$\\ \hat{α} = \overline{y} - β {}_{} \overline{x} ⌢$$

The general case for multiple variables linear regression can be obtained by similar method.

Second, submit each set of data to a least-square non-linear regression algorithm, as an example, in the case of single variable, the predictive function can be expressed with the same set of equations as in the above linear regression with the exception of replacing xᵢ with one or more higher order factors of the square, the cube, or higher order of self multiple of xᵢ. The general case for multiple variables non-linear regression can be obtained by similar method.

Third, submit each set of data to a regression neural network algorithm, where the steps are as follows:

First, define L-layers of neural layers with a number of neurons in the neural network model, where each neural layer is repeated multiple L times until we get satisfactory results with our input data. Input data X1 to Xn to the first neural layer, and data is moved forward from one neural layer to the next neural layer. Define each layer to contain N neurons where N is set in the first neural layer to be the same as the number of input sensors or more. Define the number of neurons in each subsequent layer, and the number can drop by 0% to 50% from previous layer based on the success in processing the data. Define ReLU activation layer in order to apply nonlinear operation with rectified linear unit ReLU to the data after each neural layer operation. Define final layer with one neuron and with a linear activation function for the series of function output of the regression neural network algorithm.

Outputs from the multiple regression algorithms are fed as inputs to a final least-square linear regression model, and the output from this final least-square linear regression model is used as the final result for the combination regression analysis.

When training the model, series of input data and the “commonly well accepted” series of function outputs are collected as training data and fed into the model. The prediction function F is calculated and will become more and more accurate. When the model is fully trained with enough training data, the model can be used with future new series of input data to predict the future series of function outputs as the decision parameters.

We build multiple separate models by the above combination regression analysis in predicting a number of series of function outputs Y as decision parameters to control different devices. When the decision parameter Y is greater than a certain value, a control command is send to increase or decrease the liquid flow valve, the gas flow for the enhance gas flow device, or the height distance for the height servo motor.

The first model controls the liquid flow valve to adjust the flow volume of the liquid conversion solution from the liquid reservoir to the multiple track injection liquid controller. The second model controls the servo motor to adjust the height distance from the top of the liquid reservoir to the multiple track injection liquid controller. The third model controls the servo motors to adjust the height distances from the top of the liquid inside the gas cleaning cells to the gas inlets inside the gas cleaning cells. The fourth model controls the enhance gas flow devices to adjust the gas flow and the gas pressure from the two gas chambers.

This method of liquid-to-gas conversion, its design and parameter setting, can be used to utilize artificial intelligence to control the liquid conversion solution flow, liquid pressure, gas pressure, and temperature. At the side of the electron exchanger facing the gas chamber, the liquid conversion solution is converted into final gases and directly released into the gas chambers. The power consumed by the conversion cell will be optimized.

This liquid-to-gas conversion method can be used to convert different kinds of liquid conversion solution into different kinds of gases, and this conversion method can also be used to convert liquid water to hydrogen and oxygen gases.

Multiple conversion cells can be stacked vertically and horizontally, and they can share some of the common components. More conversion cells can be placed in the same physical space to achieve higher gas production level.

### Operation:

In the following example, we describe our method using water as liquid conversion solution to generate hydrogen and oxygen gases, but the principle of our method can be generalized to apply to other types of liquid conversion solutions to generate other types of gases. The following described embodiment is only one of the, but not all, embodiments of our presented method. Based on the embodiments of our presented method, all other embodiments obtained by those of ordinary skill in the art without creative efforts shall fall within the protection scope of our presented method.

The anode electron exchanger and cathode electron exchanger are placed in the liquid-to-gas conversion cell, and the conversion cell is separated into the cathode gas chamber 210, the multiple track injection liquid controller placed inside the liquid conversion solution chamber 230, and the anode gas chamber 220.

The multiple track injection liquid controller 100 is formed by stacking together a plurality of nonconductive single sheets. Among them, the multiple track injection single sheets 120 are in the middle section, and they are protected from the left and right by the liquid control single sheets 110 and liquid retention mesh material single sheets 110.

The electron exchangers 240 and 250 facing the liquid conversion solution chamber and are in direct contact with the multiple track injection liquid controller. The other sides of the electron exchangers face the gas chambers. The surfaces of the electron exchangers are covered with puncture channels. By applying a voltage to the cathode and anode electron exchange, electrons are exchanged on the sides facing the gas chambers, and the liquid conversion solution is converted into final gases that are released into the cathode gas chamber and the anode gas chamber. Gases pass through the two gas chambers outlets to the cathode and anode gas cleaning cells 350. Gas cleaning cells are filled with a gas cleaning liquid 360. Gas bubbles rise from the gas inlets of the gas cleaning cells to the gas outlets at the top of the gas cleaning cells.

On top of the liquid inlets of the multiple track injection single sheets, a liquid flow valve 280 is placed to control the flow of liquid conversion solution 270 from the liquid reservoir 260 to the multiple track injection liquid controller 230.

The liquid conversion cell is equipped with an intelligent microprocessor (MCU) 310, which is responsible for the artificial intelligence machine learning calculation, and data is also transmitted to the local computing engine or the cloud computing engine via the Internet for calculation. The microprocessor controls the liquid flow valve and decides whether to increase or decrease the liquid conversion solution flowing from the liquid reservoir to the multiple track injection liquid controller.

Microprocessor is connected to a servo motor 340 to control the height distance from the liquid reservoir 260 to the multiple track injection liquid controller. Microprocessor is connected to servo motors 340 to control the height distances from the top of the liquid inside the gas cleaning cells 350 to the gas inlets inside the gas cleaning cells. Microprocessor is connected to two gas flow fans, acting as the enhance gas flow devices 370, to control the gas flow and the gas pressure coming from the two gas chambers.

The microprocessor is also connected to four liquid content sensors and hygrometer (HGO) 300, temperature sensors 330, pressure sensors 330, height distance sensors, gas flow sensors 320, voltage sensor, and current sensor. More sensors can be placed at selected locations within the liquid to gas conversion cell if necessary. Each liquid content sensor has a pair of resistive probes 290 to sense the liquid conversion solution level at various locations in the conversion cell. Potassium hydroxide is added to water and water is ionized to form the liquid conversion solution 270.

The water in the multiple track injection liquid controller is in contact with the cathode electron exchanger 240. Water molecules pass through the puncture channels of the cathode electron exchanger. At this location, electrons are released into the water to reduce the water to hydrogen and hydroxide ions, hydrogen gas is released into the cathode gas chamber. The hydroxide ions from the cathode electron exchanger go through the multiple track injection liquid controller, reach the anode electron exchanger 250. At this anode electron exchanger, the hydroxide ions are converted into water, oxygen and electrons. The electrons are collected by the anode electron exchanger, and oxygen gas is released to the anode gas chamber.

The result is that hydrogen and oxygen gases are released separately from the gas outlets of the two gas cleaning cells. As more gas is produced, the water in the multiple track injection liquid controller dries up, and the microprocessor senses that the water content is low at this location. After artificial intelligence calculations, the microprocessor will increase or decrease the liquid flow valve, allowing more or less water from the liquid reservoir to flow evenly and quickly into the multiple track injection liquid controller. Microprocessor and servo motors control the height distance from the liquid reservoir to the multiple track injection liquid controller. Microprocessor and two servo motors control the height distances from the top of the gas cleaning cells to the gas inlets inside the gas cleaning cells. Microprocessor controls the two enhance gas flow devices to control the gas flow and gas pressure coming from the two gas chambers. As a result, microprocessor controls the liquid and gas flow volume, the pressure and the temperature inside the liquid conversion cell.

The result of our conversion method provides an energy efficient liquid-to-gas conversion method to generate hydrogen and oxygen gases from liquid water.

### Conclusion, Ramifications, and Scope:

While the above description contains much specificity, these should not be construed as limitations on the scope of the invention, but rather as an exemplification of one preferred embodiment thereof. Many other variations are possible.

For example, we describe our method using an example of water as liquid conversion solution to generate hydrogen and oxygen gases, but the principle of our method can be generalized to apply to other types of liquid conversion solutions to generate other types of gases.

For example, we describe our method in manufacturing the puncture channels using precision technologies, comprising: chemical etching, plasma etching, laser drilling or electroforming. The puncture channels can possibly be manufactured by other kinds of technologies that are not listed in our described list of technologies, but the principle of our method can be generalized to apply to manufacturing the puncture channels with technologies that are able to create similar small openings.

For example, we describe our machine learning regression method by using a multi variable linear regression method as an illustration, but the principle of our regression method can be generalized to applying a combination of 1) single variable regression, 2) multi variable regression, 3) linear regression, and 4) nonlinear regression.

The described embodiment in the above description is only one of the, but not all, embodiments of our presented method. Based on the embodiments of our presented method, all other embodiments obtained by those of ordinary skill in the art without creative efforts shall fall within the protection scope of our presented method.

The scope of the invention should be determined not by the embodiments illustrated, but by the appended claims and their legal equivalents.

I claim:

1. A method for artificial intelligence pressure control multiple track injection conversion of liquid to gas, comprising:
placing a multiple track injection liquid controller in a liquid conversion solution chamber inside a conversion cell;
feeding liquid conversion solution to said multiple track injection liquid controller in said liquid conversion solution chamber inside said conversion cell;
placing electron exchangers, built with one or more puncture channels, in said conversion cell, comprising: cathode electron exchanger, and anode electron exchanger;
setting gas chambers in said conversion cell, comprising: cathode gas chamber, and anode gas chamber;
placing said electron exchangers in between said liquid conversion solution chamber and said gas chambers inside said conversion cell;
enabling said liquid conversion solution passing from said multiple track injection liquid controller through one or more said puncture channels of said electron exchangers;
applying a voltage to said anode electron exchanger and said cathode electron exchanger; and
converting said liquid conversion solution into gases releasing to said gas chambers in said conversion cell.

2. The method of claim 1 wherein said placing said electron exchangers in said conversion cell further comprises:
placing said electron exchangers with one conductive side and one nonconductive side in said conversion cell;
placing said nonconductive sides of said electron exchangers facing said multiple track injection liquid controller in said liquid conversion solution chamber and in contact with said liquid conversion solution in said multiple track injection liquid controller;
placing said conductive side of said cathode electron exchanger facing said cathode gas chamber; and
placing said conductive side of said anode electron exchanger facing said anode gas chamber.

3. The method of claim 1 wherein said placing said multiple track injection liquid controller in said liquid conversion solution chamber, further comprises:
building said multiple track injection liquid controller by actions selected from any combination of one or more options, comprising:
building said multiple track injection liquid controller by stacking two or more nonconductive single sheets selected from any combination of one or more options, comprising: multiple track injection single sheet, liquid control single sheet, and liquid retention mesh material single sheet;
building said multiple track injection single sheet with one or more tracks and one or more puncture channels on the surface to form a network of distribution channels to distribute said liquid conversion solution from liquid inlets of said multiple track injection single sheet to locations across said multiple track injection single sheet and to pass through;
building said liquid control single sheet with one or more puncture channels on the surface for said liquid conversion solution to pass through;
building said liquid retention mesh material single sheet using mesh materials with small pores for said liquid conversion solution to pass through;
building said single sheets and stacking said single sheets to follow design parameters and to control rate and amount of said liquid conversion solution in passing through said multiple track injection liquid controller; and
setting one or more said puncture channels from adjacent said single sheets to be out of alignment with each other, forming a pattern of interlocking said puncture channels in between adjacent said single sheets.

4. The method of claim 1 wherein said feeding said liquid conversion solution to said multiple track injection liquid controller further comprises:
feeding said liquid conversion solution by actions selected from any combination of one or more options, comprising:
placing liquid conversion solution in a liquid reservoir and feeding said liquid conversion solution from said liquid reservoir through a liquid flow valve to said multiple track injection liquid controller;
feeding said gases from gas chamber outlets of said gas chambers to gas cleaning cells filled with gas cleaning liquid; and
adjusting physical parameters, at any combination of one or more locations of said conversion cell, said liquid reservoir, and said gas cleaning cells for any combination of one or more parameter options, comprising: temperature, liquid pressure, gas pressure, liquid flow rate, and gas flow rate;

5. The method of claim 4 wherein adjusting physical parameters at any combination of one or more locations further comprises:
placing control or sensing devices at significant placement locations selected from any combination of one or more options of locations, comprising: locations inside or around said conversion cell, locations inside or around said liquid reservoir, and locations inside or around said gas cleaning cells;
placing said control or sensing devices by actions selected from any combination of one or more options, comprising:
placing valves, at any combination of one or more said significant placement locations, from any combination of one or more options of valves, comprising: liquid flow valves, and gas flow valves;
placing enhance gas flow devices to adjust gas flow at any combination of one or more said significant placement locations;
placing servo motors to adjust liquid pressure from heights of volumes of said liquid conversion solution at any combination of one or more options of devices, comprising: said liquid reservoir, and said gas cleaning cells;
placing sensors, at any combination of one or more said significant placement locations, from any combination of one or more options of sensors, comprising: liquid content sensors, temperature sensors, liquid pressure sensors, gas pressure sensors, gas flow sensors, height distance sensors, voltage sensors, and current sensors;
placing said liquid flow valve at liquid inlet of said multiple track injection liquid controller and controlling amount and rate of said liquid conversion solution flowing to said multiple track injection liquid controller;
placing said liquid content sensor at liquid inlet side of said multiple track injection liquid controller;
placing said liquid content sensor at middle area of said multiple track injection liquid controller;
placing said liquid content sensor at bottom of said cathode gas chamber;
placing said liquid content sensor at bottom of said anode gas chamber;
placing said temperature sensors in said gas chambers or said liquid conversion solution chamber;
placing said gas pressure sensors in said gas chambers;
placing said liquid pressure sensor in said liquid conversion solution chamber;
placing said voltage sensor to measure voltage applied across said cathode electron exchanger and said anode electron exchanger;
placing said current sensor to measure current applied across said cathode electron exchanger and said anode electron exchanger;
placing height distance sensors to measure heights of liquid volume at any combination of one or more options of locations, comprising: said liquid reservoir, and said gas cleaning cells;
placing said gas flow sensors at said gas chamber outlets of said gas chambers; and
placing said enhance gas flow devices at said gas chamber outlets of said gas chambers.

6. The method of claim 5 wherein said placing said control or sensing devices further comprises:
using a computing engine by combining computing capabilities with computing devices selected from any combination of one or more options, comprising: microprocessors, local based computers connected by networks, and cloud based computers connected by Internet;
using said computing engine to carry out actions from any combination of one or more options, comprising:
using said computing engine to exchange data with or to control devices selected from any combination of one or more options of devices, comprising: said sensors, said valves, said servo motors, and said enhance gas flow devices; and
enabling results from said computing engine to be read by operators in any combination of one or more remote locations through mobile phones and computer tablets.

7. The method of claim 6 wherein said using said computing engine to exchange data with or to control devices further comprises:
using said computing engine to carry out combination regression analysis with series of input data feeding from said sensors;
carrying said combination regression analysis with actions selected from any combination of one or more options, comprising:
expressing a predictive function F(X) for said combination regression analysis as:
Y=F(X1,X2, . . . ,Xn),
series of function output=Y,
series of input data from Sensor 1=X1,
series of input data from Sensor 2=X2,
series of input data from Sensor N or required gases output level=Xn;
setting Xn to 1 when said input data is within an acceptable range and setting Xn to 0 when said input data is out of said acceptable range;
training said combination regression analysis to become more accurate by feeding training data, including said series of input data and commonly well accepted values for said series of function outputs, into said combination regression analysis;
sorting each said series of input data of X1 to Xn into an ascending order, expressing the first data point of said series of input data X1 as X1.1, the mth data point of said series of input data X1 as X1.m;
calculating the increment in slope, as said series of input data moves from X1.1 to X1.m and said series of function output moves from Y1.1 to Y1.m, by dividing the increment in said series of function output, as Y1.1 moves to Y1.m, by the increment in each input data, as X1.1 moves to X1.m, and repeating these steps for all said series of input data from X1 to Xn;
detecting a significant change in the slope value to form a set of input data for this segment of data input range, grouping each said set of input data for each said segment of data input range to form a separate sub predictive function;
setting said predictive function F(X) covering the whole input data range as a combined result of all said sub predictive functions covering each said segment of data input range inside said whole input data range;
feeding each said set of input data for each said sub predictive function covering each said segment of data input range to multiple regression algorithms selected from any combination of one or more regression algorithms, comprising: least-square linear regression algorithm, least-square non-linear regression algorithm, regression neural network algorithm, and other equivalent regression algorithm;
feeding each said set of data for each said sub predictive function to said least-square linear regression algorithm to obtain said series of function output, where in the case of single variable, expressing said series of function output as yi, where:
$$\\ {y}_{i} = α + β {x}_{i} + {ε}_{i} ; β = \frac{{\sum }_{i = 1}^{n} ( {x}_{i} - \overline{x} ) ( {y}_{i} - \overline{y} )}{{\sum }_{i = 1}^{n} {( {x}_{i} - \overline{x} )}^{2}} ⌢$$
$$\\ \hat{α} = \overline{y} - \hat{β} {}_{} \overline{x} ,$$
and obtaining said series of function output for the general case for multiple variables linear regression by similar methods;
feeding each said set of data for each said sub predictive function to said least-square non-linear regression algorithm, using the same set of equations as in said least-square linear regression and by replacing input 4 with one or more higher order factors of self multiple of xᵢ to obtain said series of function output, and obtaining said series of function output for the general case for multiple variables non-linear regression by similar methods;
feeding each said set of data for each said sub predictive function to said regression neural network algorithm with steps as follows: defining a neural layer with neurons in said regression neural network algorithm, repeating to add defining said neural layer one or more times until reaching satisfactory results, inputting said series of input data X1 to Xn to the first said neural layer, moving data forward from one said neural layer to the next said neural layer, setting each said neural layer to contain N said neurons, setting N in the first said neural layer to be the same as or more than the number of said sensors, setting the number of said neurons in each subsequent said neural layer to decrease by zero to a percentage from previous layer, applying nonlinear operation with rectified linear unit ReLU to the data after each said neural layer operation, setting final said neural layer with one said neuron and with a linear activation function for said series of function output of said regression neural network algorithm;
taking said series of function outputs from one or more regression algorithms from said multiple regression algorithms as inputs feeding to a final least-square linear regression model, using series of function output from said final least-square linear regression model as series of function output for said combination regression analysis;
feeding future new said series of input data to said combination regression analysis in predicting future said series of function outputs, after said combination regression analysis is fully trained to become an accurate model; and
using said future said series of function outputs from said combination regression analysis to determine commands to send to control said sensors, said valves, said servo motors, or said enhance gas flow devices.

8. The method of claim 3 wherein said building said single sheets and stacking said single sheets to follow design parameters, further comprises actions selected from any combination of one or more options, comprising:
modeling said liquid conversion solution adhering on surfaces of said single sheets as droplets and diffusing until a partial wetting equilibrium contact radius is reached;
expressing said droplets with radius r as:
$$\\ r = \sqrt{\frac{V}{π h}} , where h = \sqrt{\frac{2 σ ( 1 - cos θ )}{ρ g}} ,$$
σ is surface tension,
g is gravitational acceleration constant,
θ is contact angle between liquid and surface,
h is height of droplet,
V is time function of volume of droplet;
expressing said droplet with said radius over time r(t) as:
$$\\ r ( t ) = {{r}_{e} [ 1 - exp ( - ( \frac{2 {γ}_{LG}}{{r}_{e}^{{}_{} 12}} + \frac{ρ g}{9 {r}_{e}^{{}_{} 10}} ) \frac{24 λ {V}^{{}_{} 4} ( t + {t}_{0} )}{{π}^{{}_{} 2} η} ) ]}^{\frac{1}{6}} ;$$
expressing said droplet with said radius over time r(t), by assuming perfect spreading of said droplets and a delay time, as:
$$\\ r ( t ) = {[ {( {γ}_{LG} \frac{96 λ {V}^{{}_{} 4}}{{π}^{{}_{} 2} η} ( t + {t}_{0} ) )}^{\frac{1}{2}} + {( \frac{λ ( t + {t}_{0} )}{η} )}^{\frac{2}{3}} \frac{24 ρ {gV}^{\frac{3}{8}}}{7 \cdot {96}^{\frac{1}{3}} {π}^{\frac{4}{3}} {γ}_{LG}^{{}_{} \frac{1}{3}}} ]}^{\frac{1}{6}} ,$$
γLG is surface tension of liquid,
V is droplet volume,
η is viscosity of liquid,
ρ is density of liquid,
g is gravitational acceleration constant,
λ is shape factor, 37.1 m−1,
t0 is experimental delay time,
re is radius of droplet at equilibrium;
making distances between adjacent one or more said puncture channels of said single sheets as a multiple of said radius over time r(t);
making radii of one or more said puncture channels of said single sheets no bigger than said radius over time r(t);
making radii of said pores of said liquid retention mesh material single sheets no bigger than said radius over time r(t);
making width of said tracks of said multiple track injection single sheets as a multiple of said radius over time r(t);
adjusting said width of said tracks of same said multiple track injection single sheet to one or more values depending on locations of said tracks on same said multiple track injection single sheet;
adjusting said distances between adjacent said puncture channels of same said single sheet and said radii of said puncture channels of same said single sheet to one or more values depending on locations of said puncture channels on same said single sheet; and
adjusting said distances between adjacent one or more said puncture channels of said single sheets, said radii of one or more said puncture channels of said single sheets, said radii of said pores of said liquid retention mesh material single sheets, and said width of said tracks of said multiple track injection single sheets based on physical parameters, at any combination of one or more locations of said conversion cell, from any combination of one or more options of parameters, comprising: temperature, liquid pressure, gas pressure, and gas flow rate.

9. The method of claim 3 wherein said building said single sheets and stacking said single sheets to follow design parameters, further comprises actions selected from any combination of one or more options, comprising:
expressing height h of a liquid column as:
$$\\ h = \frac{2 γ cos θ}{ρ g r} ,$$
γ is liquid-air surface tension coefficient (force/unit length),
Θ is contact angle,
ρ is density of liquid,
g is gravitational acceleration constant,
r is said radius over time r(t);
making thickness of one or more said puncture channels of said single sheets no thicker than said height h;
making spacing between adjacent said single sheets be no larger than said height h; and
adjusting said thickness of said single sheets and said spacing between adjacent said single sheets based on physical parameters, at any combination of one or more locations of said conversion cell, from any combination of one or more options of parameters, comprising: temperature, liquid pressure, gas pressure, and gas flow rate.

10. The method of claim 3 wherein said building said single sheets to follow design parameters, further comprises:
making one or more said puncture channels of said multiple track injection single sheets and said liquid control single sheets having design patterns from any combination of one or more options, comprising: Y-shaped, X-shaped, and star-shaped design pattern.

11. The method of claim 3 wherein said building said single sheets to follow design parameters further comprises:
manufacturing said liquid retention mesh materials single sheets by a precision material woven technology;
manufacturing said multiple track injection single sheets and liquid control single sheets with a precision technology selected from any combination of one or more options, comprising:
manufacturing said multiple track injection single sheets and liquid control single sheets in a similar way as manufacturing said electron exchangers with said puncture channels;
chemical etching by applying chemicals to etch away specific points of material to form one or more said tracks and one or more said puncture channels;
plasma etching by applying plasma to etch away specific points of material to form one or more said tracks and one or more said puncture channels;
laser drilling by repeatedly applying a pulsing focused laser to material to cut away specific spots to form one or more said tracks and one or more said puncture channels; and
electroforming by electro depositing of material onto a mandrel to form one or more said tracks and one or more said puncture channels.

12. The method of claim 1 wherein said converting said liquid conversion solution into said gases in said conversion cell further comprises with actions selected from any combination of one or more options, comprising:
converting one or more kinds of said liquid conversion solution into one or more kinds of said gases;
converting liquid water into hydrogen gas and oxygen gas;
stacking two or more said conversion cells vertically and horizontally; and
sharing common components among said two or more said conversion cells.
